(19) United States
(12) Patent Application Publication
(10) Pub. No.: US 2021/0015328 A1
(43) Pub. Date: Jan. 21, 2021

(54) HOSE COUPLING SYSTEM FOR A VACUUM CLEANER

(71) Applicant: Hilti Aktiengesellschaft, Schaan (LI)

(72) Inventors: Sonya WÖRZ, Penzing (DE); Hans RUPPRECHT, Muenchen (DE); Xaver HANSLMEIER, Mauerstetten (DE); Helmut SPECHT, Bad Woerishofen (DE); John Van TAACK-TRAKRANEN, Muenchen (DE)

(21) Appl. No.: 17/040,110

(22) PCT Filed: Mar. 18, 2019
(86) PCT No.: PCT/EP2019/056659

§ 371 Date: Sep. 22, 2020

(30) Foreign Application Priority Data
Mar. 26, 2018 (EP) 18163880.0

(51) Int. Cl. A47L 9/24

(52) U.S. Cl. CPC A47L 9/242

(57) ABSTRACT

A hose coupling system including an inlet fitting, which is to be arranged or is arranged on a vacuum cleaner, and including a tubular connection piece, which is to be connected or is connected to a suction hose, wherein the connection piece is to be inserted into the inlet fitting in the coaxial direction, wherein the hose coupling system has an actuable latching element by means of which the connection piece can be held in the inlet fitting in a form-fitting manner and can be released again as required.

The present invention relates to a hose coupling system comprising an inlet fitting and a connection piece. The inlet fitting is to be arranged or is arranged on a vacuum cleaner. The connection piece is to be connected or is connected to a suction hose. The connection piece can be inserted into the inlet fitting in the coaxial direction and can be pulled out of the inlet fitting in the coaxial direction.

### BACKGROUND

Hose coupling systems of the type mentioned at the beginning are known in principle from the prior art.

### SUMMARY OF THE INVENTION

It is an object of the present invention to provide a hose coupling system for a vacuum cleaner, which hose coupling system facilitates a comparatively simple connection of the connection piece to the inlet fitting.

The present invention provides that the hose coupling system has an actuable latching element by means of which the connection piece can be held in the inlet fitting in a form-fitting manner and can be released again as required.

The present invention includes the finding that connection pieces for suction hoses typically have a conical shape which, in interaction with a corresponding conical configuration of the inlet fitting, leads to a friction pairing between connection piece and inlet fitting. Such a conical configuration does indeed minimize possible spurious air entering the inlet fitting. On the other hand, the conically configured connection piece typically fits comparatively firmly within the inlet fitting, which is a disadvantage. In order then to remove such a connection piece from the prior art from the inlet fitting, a comparatively high pull-out force has to be applied. In addition to the high amount of effort typically required for removal, it is disadvantageously also required for the connection piece to have to be of a sufficient size such that the user's hand can surround said connection piece and pull the latter out. In addition to the great effort already mentioned, the large amount of space needed in the region of the inlet fitting of the vacuum cleaner is also a problem.

These disadvantages can be avoided by the hose coupling system according to the invention. The hose coupling system according to the invention accordingly provides the basis for a compact design of a vacuum cleaner and a connection which is easy to release, but is secure and very substantially air-tight.

In a particularly preferred refinement, the connection piece is held in the inlet fitting in a form-fitting manner when the latching element is unactuated. The latching element is preferably in the form of a spring-mounted holding clip with an outer actuating surface. An outer actuating surface should be understood as meaning in particular a surface which is actuable by a human finger or a human hand. An area of the outer actuating surface preferably amounts to at least 4 cm².

In a preferred refinement, the connection piece has an encircling latching rim with which the spring-mounted holding clip is in engagement in a form-fitting manner when said holding clip is in an unactuated state. The latching rim preferably completely encircles the connection piece. The spring-mounted latching clip preferably has a latching edge which is intended for engagement with the latching rim. Unactuated state of the spring-loaded holding clip, the latching edge can be located latching rim and first support ring.

It has proven advantageous if the spring-mounted holding clip has two holding lugs in order to hold the holding clip in a housing of the vacuum cleaner.

The latching rim particularly preferably has an oblique flank in order to facilitate latching-in of the spring-mounted holding clip.

In a further preferred refinement, the connection piece has at least one, preferably two encircling support rings in order to align the connection piece in the inlet fitting in a manner substantially free from play.

It has proven advantageous if the connection piece has a ring end surface which, when the connection piece is accommodated in the inlet fitting and latched therein, rests on a corresponding ring end surface of the inlet fitting. In the suction mode, the corresponding ring end surfaces suck onto one another and prevent, or at least minimize, undesired spurious air.

In a further preferred refinement, the connection piece has a cylindrical sealing surface which, when the connection piece is accommodated in the inlet fitting and latched therein, rests on a corresponding cylindrical sealing surface of the inlet fitting. Such corresponding sealing surfaces advantageously minimize undesired spurious air. On the other hand, a further hose, for example for a blowing function of the vacuum cleaner, can be connected in the cylindrical sealing surface or in the annular opening thereby defined in the inlet fitting. It has proven advantageous if the corresponding cylindrical sealing surface of the inlet fitting extends at most over one third of the total length of the inlet fitting.

It has proven advantageous if the connection piece is held in the inlet fitting exclusively in a form-fitting manner, in particular in a manner free from a conical pairing.

The present invention also relates to a vacuum cleaner comprising a suction hose and a hose coupling system according to the previously described type, wherein the inlet fitting is arranged on the vacuum cleaner, and the connection piece is connected to the suction hose.

Further advantages will become apparent from the following description of the figures. Various exemplary embodiments of the present invention are illustrated in the figures. The figures, the description and the claims contain numerous features in combination. A person skilled in the art will expediently also consider the features individually and combine them to form expedient further combinations.

### BRIEF DESCRIPTION OF THE DRAWINGS

In the figures, identical components and components of identical type are designated by the same reference signs. In the figures:

FIG. 1 shows a section through a preferred exemplary embodiment of a hose coupling system according to the present invention which is arranged in a vacuum cleaner, wherein an unactuated state of the holding clip is illustrated;

FIG. 2 shows the exemplary embodiment from FIG. 1 with the holding clip actuated;

FIG. 3 shows the connection piece of the preceding exemplary embodiment in detail;

FIG. 4 shows the connection piece in a perspective illustration;

FIG. 5 shows the latching element, in the form of a spring-mounted holding clip, of the exemplary embodiment from FIGS. 1 and 2; and

FIG. 6 shows a perspective view of a section through a hose coupling system, wherein the latching element is in an unactuated state.

### DETAILED DESCRIPTION

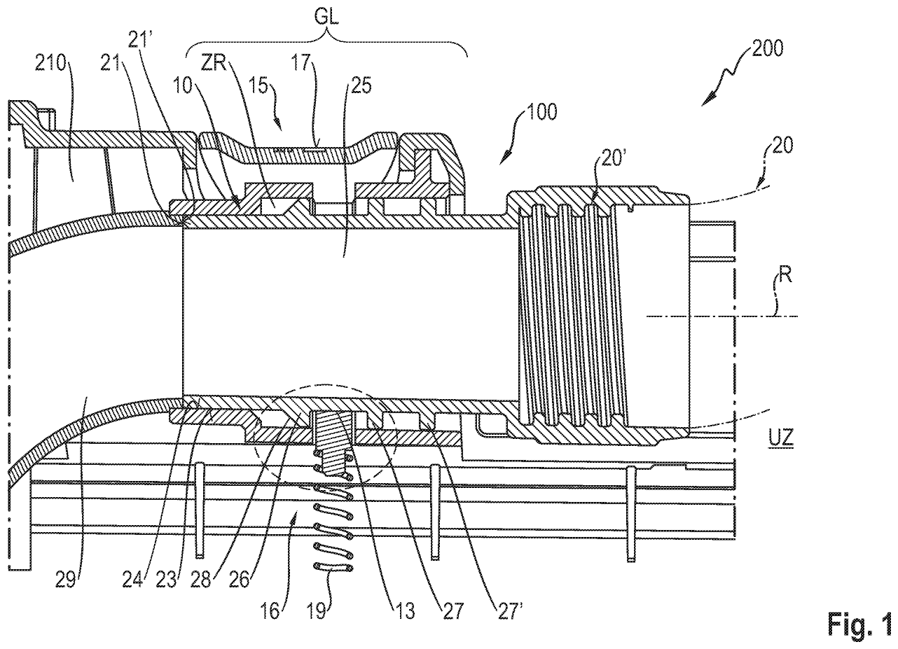

A preferred exemplary embodiment of a hose coupling system 100 according to the invention is illustrated in FIG. 1. The hose coupling system 100 is equipped with an inlet fitting 10 and a connection piece 25. The connection piece 25 has been pushed into the inlet fitting 10 in the coaxial direction R and is mounted therein.

The inlet fitting 10 is arranged on a vacuum cleaner 200, in more precise terms, is installed in a housing 210 of the vacuum cleaner. On the left side, the inlet fitting 10 is bounded by a manifold 29 of the vacuum cleaner 200. The manifold 29 leads to a suction turbine, not illustrated here.

A suction hose 20 to be connected to the connection piece 25 is illustrated merely in schematic form on the right side of FIG. 1. Such a connection hose 20 is preferably in the form of a spiral suction hose and, for its part, is held preferably in a spiral passage 20′ which is formed within the connection piece 25.

According to the invention, the hose coupling system 100 has an actuable latching element 15 by means of which the connection piece 25 can be held in the inlet fitting 10 in a form-fitting manner and can be released again as required.

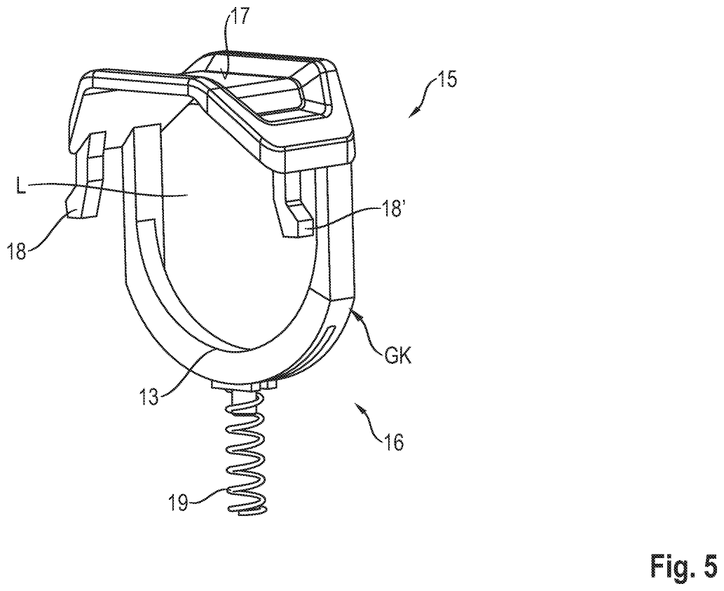

In the exemplary embodiment illustrated here, the latching element 15 is in the form of a spring-mounted holding clip 16 with an outer actuating surface 17. The spring-mounted holding clip 16 will be explained more precisely further on with respect to FIG. 5.

FIG. 1 illustrates the latching element 15, which is in the form of a spring-mounted clip 16, in section. FIG. 1 shows here the unactuated state UZ, that is to say the compression spring 19, against the force of which the latching element 15 is to be actuated, is in a maximally expanded state. In the unactuated state UZ shown in FIG. 1, the connection piece 25 is held in the inlet fitting 10 in a form-fitting manner. This is achieved by the fact that the connection piece 25 has an encircling latching rim 26 with which the spring-mounted holding clip 16 is in engagement in a form-fitting manner. This form-fitting engagement is emphasized in FIG. 1 by means of an ellipse. In this latched-in state, the connection piece 25 cannot be pulled out of the inlet fitting 10 in the coaxial direction R. It can also readily be seen in FIG. 1 that the latching rim 26 has an oblique flank 28 in order to facilitate latching-in of the spring-mounted holding clip 16 as the connection piece 25 is being pushed into the inlet fitting 10.

The preferred connection piece 25 illustrated in FIG. 1 furthermore has two encircling support rings 27, 27′ which align the connection piece 25 in the inlet fitting 10 in a manner substantially free from play. In other words, these two support rings 27, 27′ prevent the connection piece 25 from rattling within the inlet fitting 10.

Furthermore, spurious air is minimized by an intermediate space ZR which is defined between the oblique flank 28 and the inlet fitting 10, since this space constitutes, as it were, a labyrinth for possible spurious air.

As can be gathered from FIG. 1, the connection piece 25 is held exclusively in a form-fitting manner and in particular in a manner free from a conical pairing between inlet fitting 10 and connection piece 25. Due to said cone-free pairing, further structural measures are provided in order as far as possible to minimize undesired spurious air. The connection piece 25 thus has a ring end surface 21 which, when the connection piece 25, as shown, is accommodated in the inlet fitting 10 and latched therein, rests on a corresponding ring end surface 21 of the inlet fitting 10. During the suction mode, said corresponding ring end surfaces 21, 21′ suck onto one another. An annular, perpendicular contact surface is therefore realized with respect to the coaxial direction R.

As a further structural measure for minimizing the spurious air, the connection piece 25 has a cylindrical sealing surface 23 which, if the connection piece 25, as shown, is accommodated in the inlet fitting 10 and latched therein, lies against a corresponding, cylindrical sealing surface 24 of the inlet fitting 10. In the exemplary embodiment illustrated, the cylindrical sealing surface 23 has a constant cross-sectional area along a migrating cross section in the coaxial direction R. Alternatively, at least the cylindrical sealing surface can have a conical profile along the coaxial direction R in order, for example, to fasten a hose with a blowing function.

As shown with reference to the preferred exemplary embodiment illustrated in FIG. 1, the corresponding cylindrical sealing surface 24 of the inlet fitting 10 extends at most over one third of the total length GL of the inlet fitting 10.

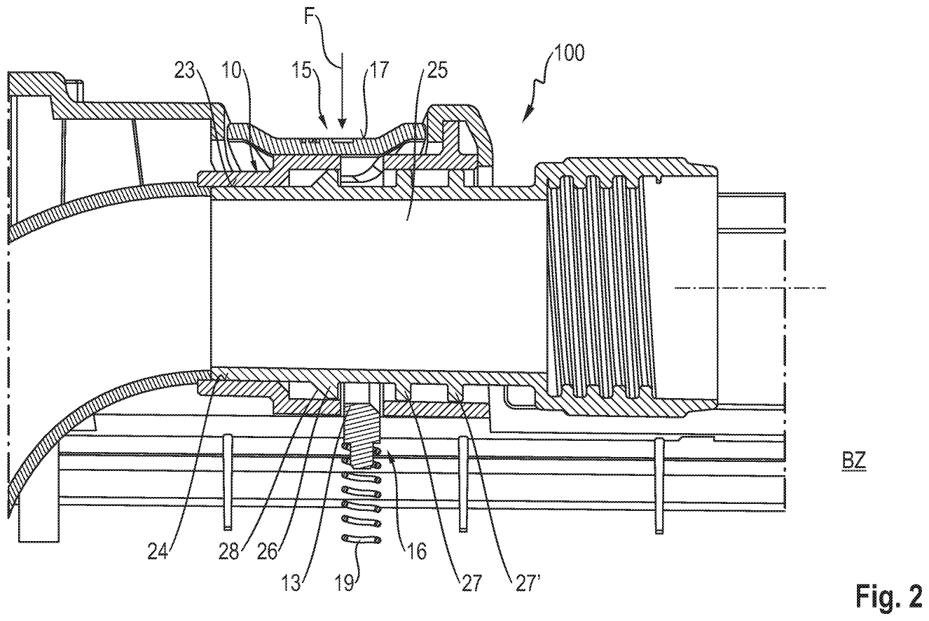

FIG. 2 now shows the hose coupling system 100 from FIG. 1, wherein the latching element 15, which is in the form of a spring-loaded holding clip 16, is illustrated in the actuated state BZ.

Said actuated state BZ is achieved by applying an actuating force F to the outer actuating surface 17 of the spring-loaded holding clip 16. The actuating force F acts counter to a spring force of the compression spring 19 here. It should be noted that a spring mounting of the holding clip 26 does not necessarily have to be achieved via a compression spring 19. Alternatively, use can be made, for example, of leaf springs, disk springs or the like as the spring element.

The actuating force F applied brings the spring-loaded holding clip 16 into the actuated state BZ shown, wherein the latching edge 13 is now no longer in engagement with the latching rim 26, in more precise terms is not located in the intermediate space between latching rim and first support ring 27.

As can be gathered from FIG. 1, the spring-mounted holding clip 16 has a latching edge 13 which is in engagement with the latching rim 16, in more precise terms is located between latching rim 26 and first support ring 27 in the unactuated state OZ shown.

In this actuated state BZ shown in FIG. 2, the connection piece 25 can be pulled effortlessly out of the inlet fitting 10 in the axial direction R. This is in particular also because the connection piece 25 is held in the inlet fitting 10 in a manner free from a conical pairing.

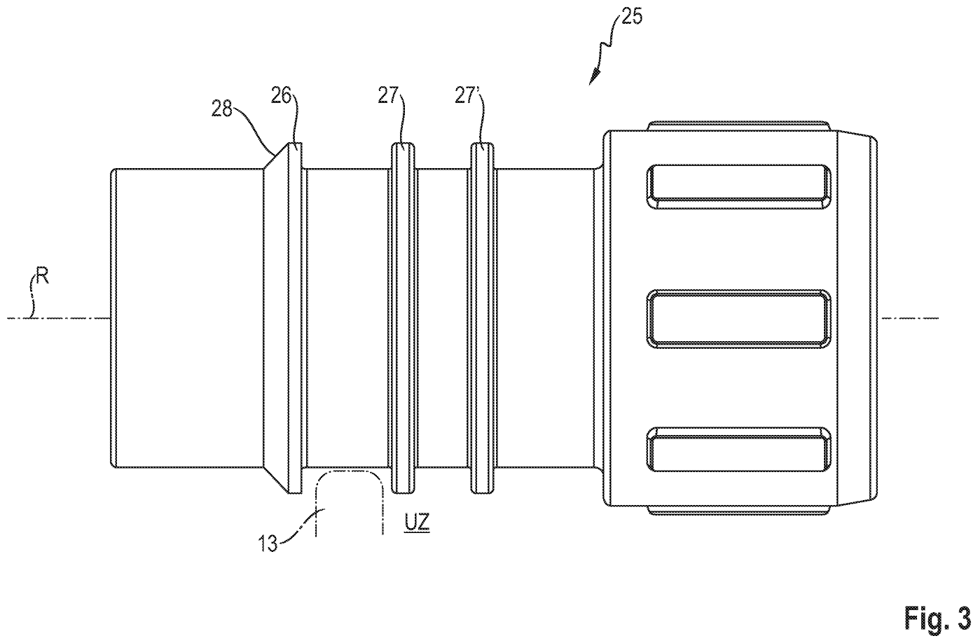

FIG. 3 now shows the preferred connection piece 25 in detail. The connection piece is cylindrical with respect to the coaxial direction R. The latching rim 26 together with its flank 28 and also the first support ring 27 and the second support ring 27′ can readily be seen. Indicated schematically on the lower side is the latching edge 13 which, in the unactuated state UZ, is arranged between the latching rim 26 and the first support ring 27 such that pulling of the connection piece 25, 10 out of the inlet fitting 10, not illustrated here, in the coaxial direction is prevented.

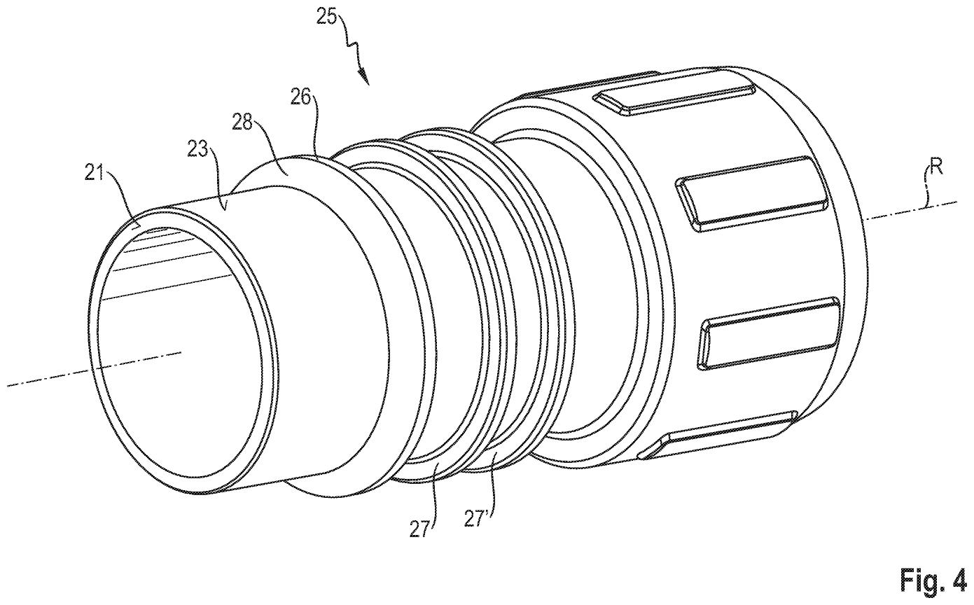

FIG. 4 now shows the connection piece 25 in a perspective illustration. The ring end surface 21 which is formed on the end side and serves for sealing the connection piece 25 in relation to the inlet fitting 10 can readily be seen (cf. FIGS. 1 and 2). The cylindrical sealing surface 23 which is formed on the end of the connection piece 25 and, in interaction with the corresponding cylindrical sealing surface 24 of the inlet fitting 10 (cf. FIGS. 1 and 2), likewise serves to minimize spurious air can also be readily seen.

FIG. 5 finally shows the latching element 15, which is in the form of the spring-mounted holding clip 16, in detail. The holding clip 16 is manufactured here integrally from plastic. The holding clip 16 has an outer actuating surface 17 which can be readily seen on the upper side in FIG. 5. Said actuating surface is partially in the form of a trough in order to facilitate operation by means of a human finger; in more precise terms, in order to avoid slipping. In the exemplary embodiment illustrated here, the actuating surface 17 has an area of at least 4 cm².

The holding clip 16 has a main body GK through which the connection piece 25 can be pushed at least in sections. The latching edge 13 which serves for the form-fitting locking of the connection piece 25 is arranged in the lower region of the main body GK, opposite the actuating surface 17. It should be noted that the latching edge 13 does not necessarily have to be in the form of a discrete, protruding latching edge, but rather, as is apparent from the exemplary embodiment shown here, can be part of the main body GK itself. The compression spring 19, against the compressive force of which the holding clip 16 is to be actuated via the actuating surface 17, can readily be seen on the lower side of the main body GK.

The spring-mounted holding clip 16 furthermore has two holding lugs 18, 18′ in order to hold the holding clip in a housing 210 of the vacuum cleaner 200.

When the connection piece 25 is arranged in the inlet fitting 10 and latched therein, the connection piece 25 is located at least in sections within the lumen L completely surrounded by the main body GK.

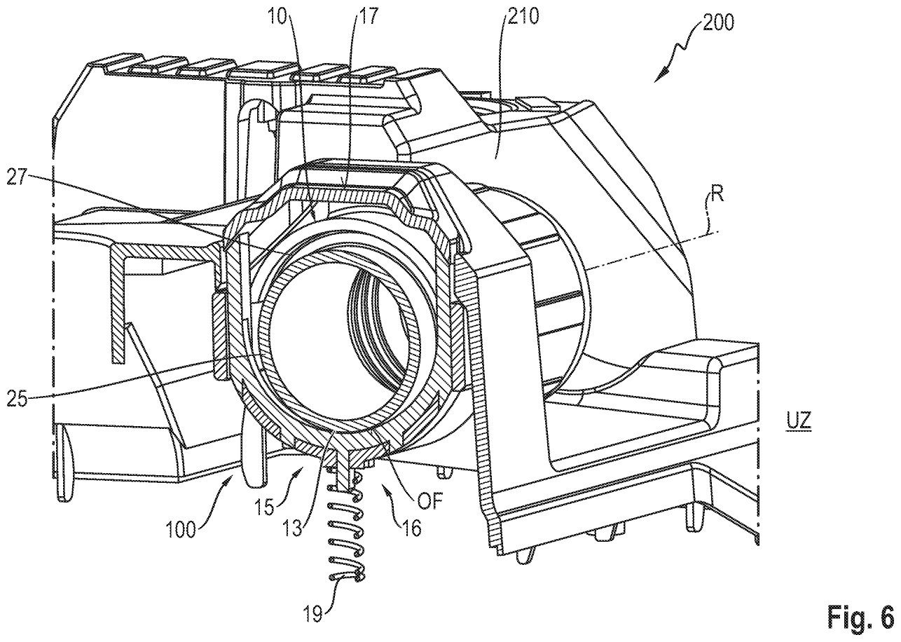

FIG. 6 now shows that hose coupling system 100 installed in a vacuum cleaner housing 210 in a perspective illustration. The latching element, which is in the form of the spring-loaded holding clip 16, is in the unactuated state UZ, wherein the latching edge 13 of the holding clip 16 rests on an area OF of the connection piece 25. Pulling of the connection piece 25 out of the inlet fitting 10 is not possible in said unactuated state UZ since the latching edge 13 lies against the latching rim 26. Owing to the sectional illustration selected here, the latching rim 26 cannot be seen, but the first support ring 27 can be seen, which first support ring, on the other hand, the intermediate space between latching rim 26 and first support ring

### LIST OF REFERENCE SIGNS

10 Inlet fitting
13 Latching edge
15 Latching element
16 spring-mounted holding clip
17 Actuating surface
18, 18′ Holding lug
19 Compression spring
20 Suction hose
20′ Spiral passage
21 Ring end surface
22′ corresponding ring end surface
23 Sealing surface
24 corresponding sealing surface
25 Connection piece
26 Latching rim
27, 27′ Support rings
28 Flank
29 Manifold
200 Vacuum cleaner
210 Housing
F Actuating force
GL Total length
GK Main body
L Lumen
OF Area
R coaxial direction
BZ actuated state
UZ unactuated state
ZR Intermediate space

1-12. (canceled)

13. A hose coupling system comprising:
an inlet fitting to be arranged or arranged on a vacuum cleaner;
a connection piece to be connected or connected to a suction hose, the connection piece to be inserted into the inlet fitting in a coaxial direction; and
an actuable latch element, the connection piece holdable in the inlet fitting in a form-fitting manner and releasable as required via the actuable latch element.

14. The hose coupling system as recited in claim 13 wherein the connection piece is held in the inlet fitting in a form-fitting manner when the latching element is unactuated.

15. The hose coupling system as recited in claim 13 wherein the latch element is in the form of a spring-mounted holding clip with an outer actuating surface.

16. The hose coupling system as recited in claim 15 wherein the connection piece has a latching rim, the spring-mounted holding clip being in engagement with the latching ring in a form-fitting manner when the holding clip is in an unactuated state.

17. The hose coupling system as recited in claim 16 wherein the latching rim is an encircling latching rim.

18. The hose coupling system as recited in claim 15 wherein the spring-mounted holding clip has two holding lugs to hold the holding clip in a housing of the vacuum cleaner.

19. The hose coupling system as recited in claim 15 wherein the latching rim an oblique flank to facilitate latching-in of the spring-mounted holding clip.

20. The hose coupling system as recited in claim 13 wherein the connection piece has at least one encircling support rings to align the connection piece in the inlet fitting in a manner free from play.

21. The hose coupling system as recited in claim 20 wherein the at least one encircling support ring is two encircling support rings.

22. The hose coupling system as recited in claim 13 wherein the connection piece has a ring end surface, the ring end surface, when the connection piece is accommodated in the inlet fitting and latched therein, resting on a corresponding ring end surface of the inlet fitting.

23. The hose coupling system as recited in claim 13 wherein the connection piece has a cylindrical sealing surface, the cylindrical sealing surface, when the connection piece is accommodated in the inlet fitting and latched therein, resting on a corresponding cylindrical sealing surface of the inlet fitting.

24. The hose coupling system as recited in claim 23 wherein the corresponding cylindrical sealing surface of the inlet fitting extends at most over one third of a total length of the inlet fitting.

25. The hose coupling system as recited in claim 13 wherein the connection piece is held in the inlet fitting exclusively in a form-fitting manner.

26. The hose coupling system as recited in claim 25 wherein the connection piece is held in the inlet fitting in a manner free from a conical pairing.

27. A vacuum cleaner comprising:
a suction hose; and
the hose coupling system as recited in claim 13, wherein the inlet fitting is arranged on the vacuum cleaner, and the connection piece is connected to the suction hose.
